(19) United States
(12) Patent Application Publication
(10) Pub. No.: US 2006/0208482 A1
(43) Pub. Date: Sep. 21, 2006

(54) Connection sleeve for rotatably connecting to hose

(76) Inventor: Wen-Li Guo, Chang Hua Hsien (TW)

Correspondence Address: CHARLES E. BAXLEY, ESQ., 90 JOHN STREET, THIRD FLOOR, NEW YORK, NY, 10038, US

(21) Appl. No.: 11/204,327

(22) Filed: Aug. 15, 2005

(30) Foreign Application Priority Data
Mar. 18, 2005 (CN) 200510024488.2

(51) Int. Cl. F16L 27/00

(52) U.S. Cl. 285/272; 285/278; 285/281

(57) ABSTRACT

A hose assembly includes a connection sleeve and a connection member 20 rotatably received in the connection sleeve. The connection sleeve has a first flange extending from an inner periphery thereof and a second flange extends from an outer periphery of the connection member so that an underside of the first flange is overlapped on the second flange. An annular lip extends outward from an outer periphery of an end of the connection member and is rested on a top of the first flange. The handle includes a connection end with outer threaded periphery for being connected with a watering nozzle.

### FIELD OF THE INVENTION

The present invention relates to a hose assembly which allows users to rotate the watering nozzle relative to the hose.

### BACKGROUND OF THE INVENTION

A conventional hose assembly includes a threaded end connected to one end of the hose and the watering nozzle is threadedly connected to the threaded end. The users then hold the handle of the watering nozzle to watering garden. However, the watering nozzle is fixed to the threaded end so that the hose could be twisted or bent when watering the garden and water in the hose is stopped if the hose the twisted.

The present invention intends to provide a hose assembly wherein the connection sleeve to which the watering nozzle is connected can be rotatable relative to the hose.

### SUMMARY OF THE INVENTION

The present invention relates to a hose assembly that comprises a connection sleeve having a through hole defined axially therethrough and a first flange extends from an inner periphery of the through hole. A connection member has a passage defined axially therethrough and a second flange extends from an outer periphery thereof. The connection member is inserted in the through hole an underside of the first flange is overlapped on the second flange. An annular lip extends outward from an outer periphery of an end of the connection member and is rested on a top of the first flange.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hose assembly of the present invention;

FIG. 2 is a cross sectional view of the hose assembly of the present invention, and

FIG. 3 is a cross sectional view of another embodiment of the hose assembly of the present invention.

### DETAILED DESCRIPTION OF THE PREFERRED EMBODIMENT

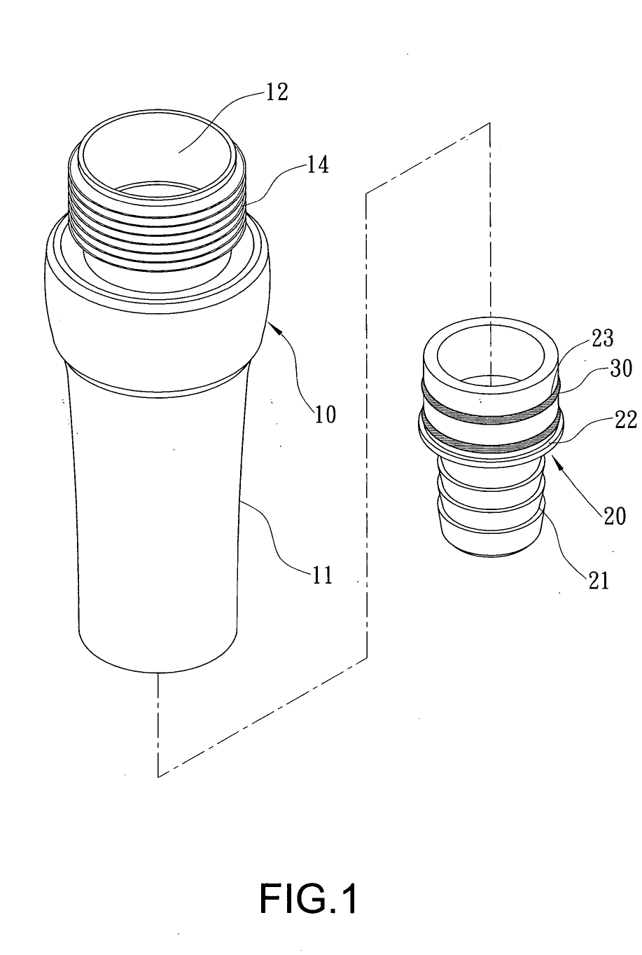

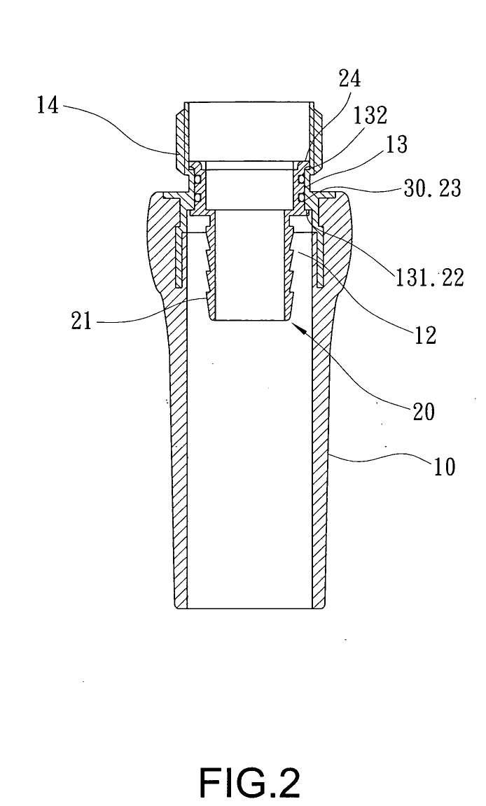

Referring to FIGS. 1 and 2, the hose assembly of the present invention comprises a connection sleeve 10 having a through hole 12 defined axially therethrough and a first flange 13 extends from an inner periphery of the through hole 12. The connection sleeve 13 further includes a soft handle 11 and a connection end 14 with outer threaded periphery to which a watering nozzle (not shown) is connected.

A connection member 20 has a passage defined axially therethrough and a second flange 22 extends from an outer periphery thereof. The connection member 20 is inserted in the through hole 12 in the connection sleeve 10 and an underside of the first flange 13 is overlapped on the second flange 22. An annular lip 24 extends outward from an outer periphery of an end of the connection member 20 and is rested on a top 132 of the first flange 13. The connection member 20 includes a connection section 21 so that a hose (not shown) is connected to the connection section 21. The connection member 20 includes receiving grooves 23 defined in the outer periphery thereof and seals 30 are engaged with the receiving grooves 23 so as to prevent leakage between the connection sleeve 10 and the connection member 20. Therefore, the connection sleeve 10 can be rotatable relative to the connection member 20.

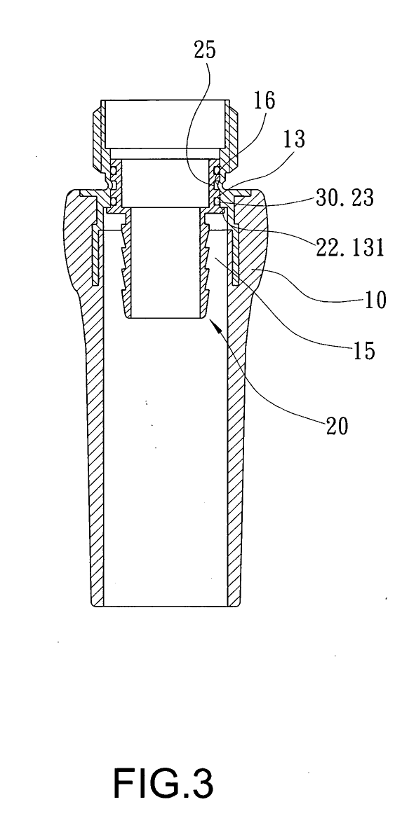

FIG. 3 shows another embodiment of the hose assembly wherein a positioning protrusion 16 extends from the inner periphery of the first flange 13 of the connection sleeve 10. The connection member 20 has a recess 25 defined in an outer periphery of an end thereof so that the positioning protrusion 16 of the connection sleeve 10 is engaged with the recess 25 in connection member 20.

While we have shown and described the embodiment in accordance with the present invention, it should be clear to those skilled in the art that further embodiments may be made without departing from the scope of the present invention.

What is claimed is:

1. A hose assembly comprising:
a connection sleeve having a through hole defined axially therethrough and a first flange extending from an inner periphery of the through hole, and
a connection member having a passage defined axially therethrough and a second flange extending from an outer periphery thereof, the connection member inserted in the through hole in the connection sleeve and an underside of the first flange being overlapped on the second flange, an annular lip extending outward from an outer periphery of an end of the connection member, the annular lip rested on a top of the first flange.

2. The assembly as claimed in claim 1, wherein the connection sleeve includes a soft handle and a connection end with outer threaded periphery.

3. The assembly as claimed in claim 1, wherein the connection member includes a connection section which is adapted to be connected to a hose.

4. The assembly as claimed in claim 1, wherein the connection member includes receiving grooves defined in the outer periphery thereof and seals are engaged with the receiving grooves.

5. A hose assembly comprising:
a connection sleeve having a through hole defined axially therethrough and a first flange extending from an inner periphery of the through hole, a positioning protrusion extending from the inner periphery of the first flange;
a connection member having a passage defined axially therethrough and a second flange extending from an outer periphery thereof, the connection member inserted in the through hole in the connection sleeve and an underside of the first flange being overlapped on the second flange, a recess defined in an outer periphery of an end of the connection member, the positioning protrusion engaged with the recess in connection member.

6. The assembly as claimed in claim 5, wherein the connection sleeve includes a soft handle and a connection end with outer threaded periphery.

7. The assembly as claimed in claim 5, wherein the connection member includes a connection section which is adapted to be connected to a hose.

8. The assembly as claimed in claim 5, wherein the connection member includes receiving grooves defined in the outer periphery thereof and seals are engaged with the receiving grooves.
